(19) United States
(12) Patent Application Publication
(10) Pub. No.: US 2014/0152019 A1
(43) Pub. Date: Jun. 5, 2014

(54) Voorhees Enhanced Kinetic Energy Generator and Storage Device

(71) Applicant: Rob Voorhees, Versailles, KY (US)

(72) Inventor: Rob Voorhees, Versailles, KY (US)

(73) Assignee: Rob Voorhees, Versailles, KY (US)

(21) Appl. No.: 13/686,835

(22) Filed: Nov. 27, 2012

(51) Int. Cl. H02K 7/18

(52) U.S. Cl. CPC H02K 7/1853
USPC 290/1 E

(57) ABSTRACT

An integrated alternative energy generator that does not require batteries or traditional outside fuels having a kinetically enhanced ratcheted loading bar 3 comprised of a one or several primary loading gears 9 and 4 that either wind up a singular mainspring assembly, a plurality of mainspring assemblies, or singular dynamo, or a plurality of dynamos simultaneously that when released by disengaging a braking system FIG. 5A, FIG. 5B, FIG. 5C allows either spring assemblies 29,31,61, and 63 to rapidly unwind thus turning dynamos 15 and 57 that induce an electrical current used for immediate electrical energy or stored electricity via spring assemblies 29,31,61,and 63 thus capable of well over 1000 watts of electrical output.

### CROSS REFERENCE TO RELATED APPLICATIONS

This application claims the benefit of Provisional Patent 61/629,861 filed Nov. 28, 2011

### BACKGROUND—DISCUSSION OF PRIOR ART

Since Michael Faraday's historic discovery of electro-magnetic induction in the 1800s, a plethora of methodologies have arisen regarding the turning of his dynamo as it later was called. Among the primary energy sources used to turn a dynamo are coal, gas, hydro, nuclear, wind, and oceanic wave. Given the vulnerability of the American electrical grid there has been a new found re emergence of human powered dynamos or generators; particularly since cyber security has become such a national security concern as it relates to the grid.

Most every major department involving the defense of our country, concede that a major disaster is highly likely once a cyber security event “takes down” the grid. An unprecedented race toward onsite energy has now begun. Given this back drop, the human powered generator resurgence is on the rise in parallel with wind power, solar power, and other renewable energy solutions. In addition to this human powered generator trend is the propensity toward non battery electrical storage solutions to accommodate technologies ranging from wind, solar, and natural gas.

Such solutions that combine both human powered generation and non battery electrical storage have existed since 1911. However, these hybrid renditions of electrical generation and storage have remained at the micro generation level of 400 watts or less. This is primarily because an average human being can produce an estimated 100-300 watts of electricity when powering a dynamo. This small wattage range has left the human population in dire need for a larger more efficient dynamo that significantly enhances human kinetic energy to make it a more viable device to power both residential and commercial electrical devices. This is particularly true since an average American home uses 1500-2400 watts per hour versus the 300-400 watts currently produced by prior art.

Most of these human powered generators that produce 400 watts exist in the form of bicycle generators connected to a battery. Some are hand powered in nature but usually produce substantially less electrical energy.

U.S. Pat. No. 983,472 Mead in 1911, U.S. Pat. No. 1,484,493 by Hargo in 1924, U.S. Pat. No. 2,490,309 by Lehman in 1946, U.S. Pat. No. 3,099,402 by Speck in 1961, U.S. Pat. No. 9224246.0 UK filing by Bayliss 1993, U.S. Pat. No. 5,668,414 by Hiroshi and Takakura 1997, U.S. Pat. No. 5,880,532 by Stopher in 1999, U.S. Pat. No. 6,588,919 by Millar in 2003, all combine both electrical generation and storage to some degree.

However, I have noticed that these prior art forms along with a plethora of bicycle powered generators were limited by four primary factors; the amount of human kinetic energy that could be input into the generator, the size of springs that could be used due to kinetic input limitations, how many springs could be wound simultaneously, and how many springs could be released in sequence. In addition, prior art such as U.S. Pat. No. 7,834,471 by Cripps in 2010 may have greater output capacity than prior art but Cripps lacks the practical integration of human kinetic input that provides mechanical energy without the need for any outside energy source.

### ADVANTAGES

It is therefore the objective of these several embodiments to provide an integrated generator and storage device that provides the advantages of prior art with regards to human kinetic input without the limitations of micro generation output while simultaneously providing the advantages of prior electrical storage devices without the disadvantages of the sole dependency of outside energy sources. In essence, a true hybrid of commercially viable generation and storage well above previous limited outputs is now embodied in the current device.

Furthermore it is not necessarily the intention of the device to provide specific circuit board design requirement, rather to provide an electrical energy source that is capable of producing over 1500 watts either on an immediate basis or a residual basis whichever is economically feasible for the end user without the sole reliance of an outside energy source and without the need for batteries. The circuit boards that parallel with the device can either be standardized or customized based on the needs of the end user but at minimum will provide the ability to power actuators that sequentially release springs according to the end user needs mentioned earlier. The net result is an integrated loading system of human kinetic or kinetic input to either a singular or plurality of dynamos or springs that induce electricity without the sole need for outside energy sources or batteries. Of course batteries can be charged and are optional to use in conjunction with the device but they are not required.

While it is widely understood that it is impossible to get more energy out of something than is put into something, a primary advantage of the current art is to significantly enhance human kinetic input which in turn will significantly enhance both the electrical output and storage capabilities of human powered equipment. As a matter of fact, these significant enhancements will enable the once recreational and micro generation capabilities of human powered equipment to become viable residential and commercial solutions within the renewable energy industry. To introduce these enhancements a bit of kinesiology, physics, and horology should be reviewed.

First, most hand cranked generators utilize smaller muscle groups within the wrist and forearm. Because VEKE will utilize much larger muscle groups such as the legs, back, and biceps to maximize human kinetic input; an exponentially increased amount of energy can be utilized for output. It should therefore be apparent that from a kinesiology standpoint, larger muscles will produce more potential energy as it relates to kinetic input. Additionally, most bicycle generators do not utilize any leverage nor do they maximize well established physics principles to increase available output. Rather they rely on antiquated bike riding styles. Anticipated versions of VEKE will utilize well known leveraging techniques as well as the principles of torque outlined in the next paragraph to maximize human kinetic input as it relates to bicycle type versions of the invention.

Secondly, well known physics facts clearly indicate that within the realm of torque the longer a bar extends past an axis and the more force applied to the end of that bar the more torque will applied to the axis itself. Additionally, the heavier the bar or the more force applied to the aforementioned bar, the greater the torque. The result of increased torque is increased potential energy. The loading system used in VEKE will therefore utilize these principles.

Thirdly, within the realm of horology it is well known that some clocks can last 400 days or longer. Currently there are horological efforts underway to create a 10 year clock. Horology not only offers insight into the length of time in which kinetic energy can last, but also the amount of potential energy a very large spring can offer as electrical output when combined with the well known Faraday principles of a dynamo. Until the advent of the current invention however, the amount of human kinetic input has been entirely too small to utilize a very large dynamo capable of 1500 watts or more. Additionally, the amount of human kinetic input has been entirely too small to utilize very large main springs capable of winding a dynamo of 1000 watts or greater.

### SUMMARY

While multiple embodiments are easily envisioned, an embodiment of a torsion loading bar with an attached gear or gears that when engaged to a series of other gears or gear train eventually engages either a singular or plurality of torsion springs and dynamos capable of scaled outputs induce electricity from small wattages to well over 1000 watts without the need for batteries or fuel as well as a spring driven storage capacity to delay the output of the induced electricity.

### DRAWINGS

FIG. 1 Depicts a top cross sectional view of a loading bar that is flat to the ground connected to a gear train which provide direct kinetic rotational energy to a singular dynamo and manual braking system

FIG. 2 Depicts a front cross sectional view of the VEKEGen in near entirety with a loading bar with a plurality of primary loading gears which load a plurality of spring assemblies which sequentially unwind thus creating residual rotational kinetic energy to plurality of dynamos

FIG. 3 Depicts an expanded view of a ratcheted loading bar

FIG. 4 Depicts a ratcheted paw and gear relationship

FIG. 5A Depicts an engaged hybrid manual and actuated braking system that slows and stops a dynamo

FIG. 5B Depicts a disengaged hybrid manual and actuated braking system that slows and stops a dynamo

FIG. 5C Depicts a locking system design for the disengagement of a braking system

### REFERENCE NUMERALS

1. Loading Bar Handle
3. Ratcheted Loading Bar
4. Primary Loading Gear 2
5. Right Ratchet Assembly
6. Ratchet Reversing Switch
7. Left Ratchet Assembly
8. Drive Gear 2
9. Primary Loading Gear 1
10. Tertiary Gear 1
11. Loading Gear 1
12. Tertiary Gear 2
13. Loading Gear 2
14. Tertiary Gear 3
15. Dynamo 1
17. Manual Brake Knob
19. Male Disengaging Bar
20. Braking Spring
21. Braking Pad
22. Female Disengaging Slot
23. Frame
25. Rotary Shaft 1
27. Paw Assembly
29. Spring Assembly 1
31. Spring Assembly 2
33. Drive Gear 1
35. Ancillary Loading Gear 1
36. Tertiary Gear 4
37. Dynamo Lead 1
39. Dynamo Lead 2
40. Circuit Board 1 Actuator Lead
41. Circuit Board 1
43. Circuit Board Connecting Wire
45. Circuit Board 2
47. Dynamo Lead 3
49. Dynamo Lead 4
51. Circuit Board 2 Actuator Lead
53. Actuated Braking System
55. Actuated Braking System Brake Pad
57. Dynamo 2
59. Ancillary Loading Gear 2
60. Tertiary Gear 5
61. Spring Assembly 3
63. Spring Assembly 4
65. Rotary Shaft 2
67. Loading Gear 3
69. Paw Assembly 2

### DESCRIPTION

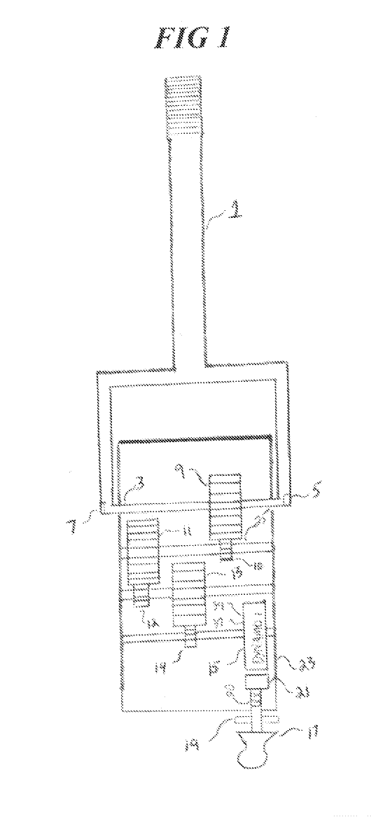

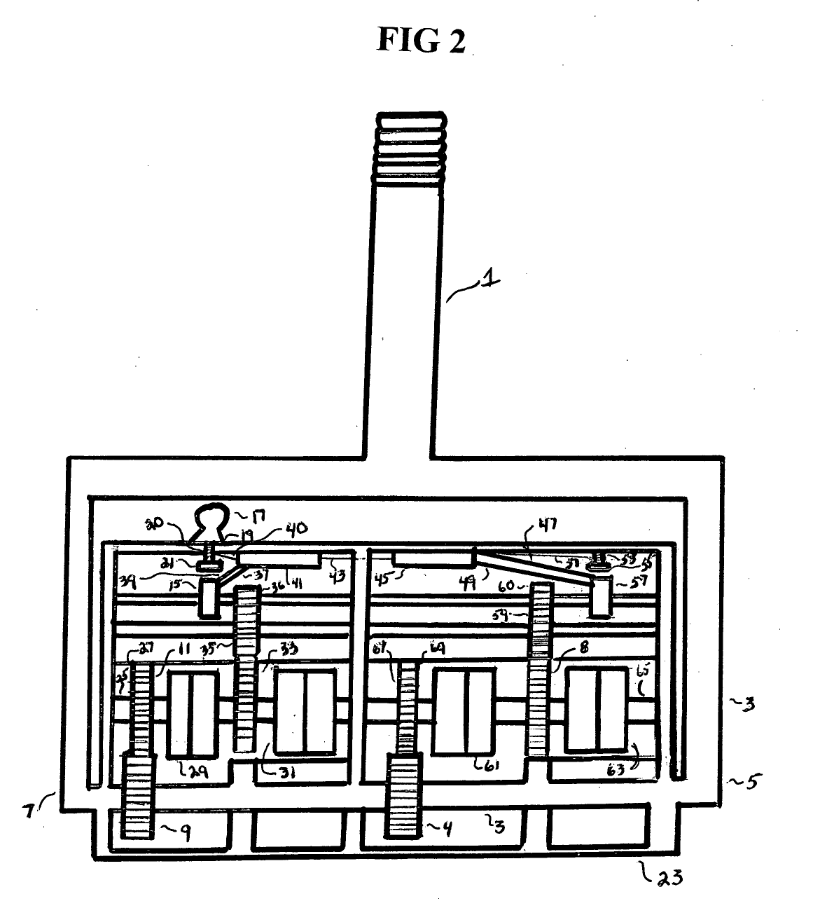

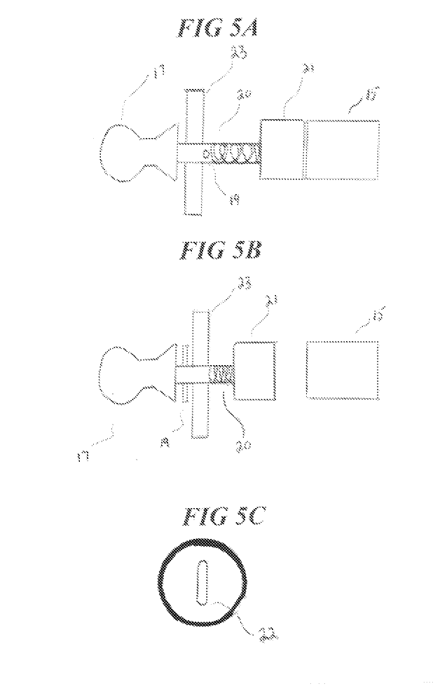

In one embodiment of the embodiment is FIG. 1 in which a loading bar handle 1 is connected to a ratcheted loading bar 3 and ratchet capable via a right ratchet assembly 5 and a left ratchet assembly 7. Attached to the loading bar 3 is a primary loading gear 9 which is connected to a loading gear 1 11 via a shaft and tertiary gear 1 10 which in turn is connected via a shaft and tertiary gear 2 to a loading gear 2 13. The loading gear 2 13 is then connected to a tertiary gear 3 14 which is then connected to a dynamo 1 which is manually braked with a brake assembly FIG. 5A, 5B, 5C comprised of a braking pad 21 which is manipulated by a braking knob 17 and a male disengaging bar 19 as it passes through a female disengaging slot 22. This first embodiment is enclosed within a metal frame 23 which is illustrated in thick black ink to differentiate it throughout the drawings. The exception is that the thick black ink on a portion of the ratcheted loading bar 3 in FIG. 2 is intentional as well to add contrast to the components illustrated in FIG. 2.

FIG. 2 is an embodiment in which a ratcheted loading bar 3 is wound via human kinetic input with a loading bar handle 1 via an attached primary loading gear 1 9 and a primary loading gear 2 4 are connected to a loading gear 1 9 and a loading gear 3 67 to eventually load torsion springs 29, 31, 61, and 63 via a paw assembly 27 and paw assembly 2 69 that holds tension until springs 29,31,61, and 63 are released via a brake assembly FIG. 5A, 5B, 5C comprised of a manual brake knob 17, male disengaging bar 19, braking spring 20 and a braking pad 21.

Once the springs 29, 31, 61, and 63 are loaded and released the potential energy is distributed through a gear train comprised of a drive gear 33, an ancillary gear 35, a tertiary gear 36, then to a dynamo 1 15. The rotating dynamo converts the rotational energy derived from the aforementioned gears into electrical energy and distributes the electrical energy to a circuit board 41 via lead wires 37 and 39.

This electrical energy is then distributed to a circuit board 2 via a circuit board 2 lead wire 43 and then distributed to an actuated braking system 53 via a circuit board actuator lead 51 and utilized to release and manage an actuated braking system brake pad 55.

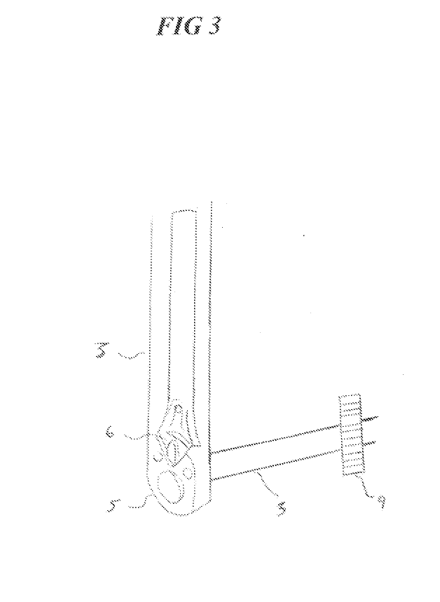

FIG. 3 is a depiction of a ratcheted loading bar 3 which is comprised of a right ratchet assembly 5 designed in similarity to a typical ratchet wrench a left ratchet assembly 7 which is not seen in FIG. 3 but is alluded to in FIG. 2 and a ratchet reversing switch 6.

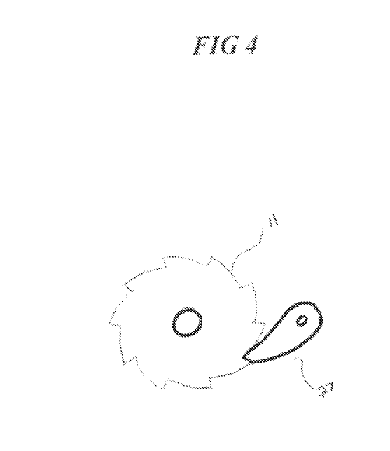

FIG. 4 is a depiction of a paw and gear assembly comprised of a paw assembly 27 and a loading gear 1 9 with duplicate arrangement in paw assembly 69 and loading gear 67 not shown in FIG. 3 but shown in FIG. 2.

FIG. 5A is a depiction of an engaged hybrid manual and actuated braking system comprised of a manual brake knob 17 a male disengaging bar 19 which passes through a female disengaging slot 22 a braking spring 20 and a braking pad 21.

FIG. 5B is a depiction of a disengaged view of the braking system with the same components as FIG. 5A and FIG. 5C is a top view depiction of the female disengaging slot 22.

### OPERATION

As mentioned earlier in the specification there are several embodiments of the invention but the overall advantages of electrical generation and electrical storage will became quite evident as the operation of a few of the embodiments are disclosed in this section. Some embodiments that maximize and enhance kinetic input and thereby generate electricity by rotating a singular or plurality of dynamos do not need torsion springs. Other embodiments will utilize this enhanced kinetic input to wind very large torsion springs which in turn will rotate a singular or plurality of dynamos with either on an immediate basis or a delayed basis since the torsion springs can unload at anytime desired thus magnifying the electrical storage capabilities of the device . Yet other embodiments will become more hybrid in nature meaning other outside sources can be used to wind up the springs and use the device primarily for storage with the enhanced kinetic input as a back up as would be the case with wind, solar, turbine versions of gas and coal or nuclear.

The choice of embodiments will be determined by consumer cost, alternative electrical generation requirements, and electrical storage demands. Some embodiments might only need the enhanced kinetic input to rotate a dynamo as in the case for emergency back up to jump starting automobile batteries to light residential and recreational versions for camping. Other versions will include the enhanced kinetic human input along with the torsion springs to add longevity measured in hours rather than minutes. Yet other versions might entail incredibly large torsion springs primarily used for storage with a smaller segment used for emergency back up in the case of natural gas, nuclear, wind, and solar types of applications.

Since the various embodiments are completely scalable other applications both smaller and larger than the aforementioned are well within the reach of the invention.

With this in mind, an embodiment of the device can be understood beginning with FIG. 1 a top cross sectional view a loading bar handle 1 of strong enough material as to wind a ratcheted loading bar 3 which has attached to it a primary loading gear 1 9. It is noteworthy to know that the length and weight of this ratcheted loading bar is of utmost importance because it is these two factors which eventually determine how much torque is applied to either the rotation of a dynamo 1 15 for example or as will later become disclosed a spring assembly 1.

It is well established knowledge within the realm of physics that the longer a lever is and the heavier a lever is the greater the torque applied to an axis. It is also well established that within the realm of kinesiology that typically the larger the muscle group used, the more force can be applied. A good example of this principle is when an individual is trying to loosen a very tight bolt with a wrench but cannot until a pipe is placed at the end of the wrench so the individual can use more weight and larger muscles to unlock the bolt. The physics of a longer lever, a heavier lever, and the kinesiology principle of larger muscle groups apply to the success of loosening the bolt.

As can be readily seen in FIG. 1 the novelty of a ratcheted loading bar 3 versus prior art attempts of rotating a dynamo or winding large torsion springs will provide an exponential amount of increased kinetic input thus an exponential amount of increased electricity.

Estimated foot pound torque for some of prior art is in the 20-100 foot pound range whereas a three to four foot long ratcheted loading bar that weighs a mere five pounds versus the lighter versions of prior art that were more circular in nature rather than levered, could land in the 2000 foot pound range. Torque wrenches off the shelf can range up to 2000 foot pounds not including any hydraulic enhancements. It should be noted at this point that hydraulic intervention is another embodiment that is easily attained to increase torque without the need for outside fuel or batteries. As a manual hydraulic lift can hoist a 2000 pound car with only human intervention, likewise a hydraulic enhancement to the ratcheted loading bar 3 could accomplish likewise. This is easily anticipated because hydraulic torque wrenches are readily available but also adds significant cost to the device.

In essence, the ratcheted loading bar can be very large in size and weight or very small in size and Weight depending on the application. A recreational version for camping would weigh much less than a version designed to power a house which is attainable with a larger version capable of over 1500 watts.

So then, the ratcheted loading bar 3 has an attached primary loading gear 1 9. An individual then cranks the ratcheted loading bar 3 which then turns a primary loading gear 1 9 which turns a tertiary gear 1 10 which turns a loading gear 1 11 which turns a tertiary gear 2 12 which turns a loading gear 2 13 which turns a tertiary gear 3 14 which rotates a dynamo 1 15 as the gear train is attached to a frame 23 in similar fashion seen in clock movements.

It should be noted here that the gears in this gear train can be greatly varied in material and size. Light weight plastic gears could be appropriate for light duty portable versions while heavy metal of hybrid gears would be appropriate for more industrial applications. Additionally, the size and number of the gears are dependent upon the application. A gear train designed to increase rotational speed might be comprised of more gears that descend in size rapidly whereas more immediate applications might require fewer gears larger in size. Similarly, the length and weight of the ratcheted loading bar 3 also can vary and length, weight, and material depending on the application.

As should be obvious to one skilled in the art, the dynamo 1 15 has attaching lead wires 37 and 39 that can be connected to a programmable logic center or circuit board, or an application such as charging a battery with or without an inverter, connecting to a device, or being wired directly to a circuit box.

A braking system see FIG. 5A, 5B, 5C is comprised of manual braking knob 17 a male disengaging bar 19 a braking spring 20 and a braking pad 21 together allow an individual to either slow or stop the rotation of the dynamo 1 15 by simply engaging or disengaging similar to a braking system in a car. As seen in FIG. 5A the manual knob 17 turns the male disengaging bar 19 vertically to pass through a female disengaging slot 22 FIG. 5C and is then turned horizontally to begin braking the dynamo 1 15 while a braking spring 20 assists in applying pressure to the dynamo 1 15.

Once there is no longer a need to slow or stop the dynamo 1 15 one simply turns the braking knob 17 vertically and pulls the male braking bar 19 back through the female disengaging slot 22 and then turns the male braking bar 19 horizontally to lock it in place and disengage the brake. It should be noted here that while the current location of the braking system engages directly with the dynamo 1 15, it can just as easily engage with any gear in the gear train as well.

As will be illustrated later, much more sophisticated interconnections to this ratcheted loading bar 3 will arise. However, it should readily be seen that this embodiment easily surpasses prior forms of rotating a dynamo kinetically. The length and weight of the bar can be customized to many applications as well as adjusted for leg movement versus arm movement. Instead of traditional bike riding with a six inch radius for a pedal a three foot 5 pound lever rather than pedal would dramatically enhance the kinetic input of a riding machine versus a bicycle. Additionally, the electrical output would far exceed the 1500 watt estimates with arm movement. When positioning the riding machine seat to mimic that of a leg press versus a bicycle even more leverage and torque would result.

It should then be obvious that with the novelty of the Voorhees Enhanced Kinetic Energy Generator and Storage Device that 400 watt limitation on dynamo output is now a thing of the past. Electrical outages of the past now have a solution that do not require dangerous fuels, connection to the grid, or batteries . . . although charging batteries could be useful and in some embodiments such as FIG. 1 could help mitigate costs of some of the more advanced embodiments as seen in FIG. 2. Homes can now have an effective back-up generator. Cars can now have a jump start even if no one is around. Emergency radios and HAM radios now have power anywhere any time. The applications are many and varied. Yet this is just the simplified embodiment of the Voorhees Enhanced Kinetic Energy Generator and Storage Device capable of over 1000 watts. We will now delve into the inner workings of a more advanced embodiment as seen in FIG. 2.

The embodiment in FIG. 1 is more of a direct electrical induction dynamo meaning that as an individual cranks the ratcheted loading bar 3 thus turning the gears in the gear train and rotating the dynamo 1 15 the electricity that is generated is either used or lost. That is to say there really is no storage unless a battery is attached either to a circuit board or to leads 37 and 39. As a result once an individual discontinues cranking the ratcheted loading bar 3, electricity is no longer generated. As mentioned this embodiment is likely to be much less of an investment than the embodiment to be disclosed in FIG. 2 and is likely to weigh much less as well. In essence, the market for this embodiment is slightly different than the market for the embodiment of FIG. 2.

The FIG. 2 embodiment however, will continue to generate electricity without human kinetic invention due to the storage capabilities of spring assemblies 1,2,3,4 numbered 29, 31, 61, and 63 respectively. The spring assemblies 1 through 4 numbered 29, 31, 61, and 63 respectively are each dual springs mirroring the old Victrola motors. However these springs can just as easily be single staged springs as well. Also, one spring or 20 springs can be wound simultaneously depending on their size and length. These springs are wound simultaneously by the ratcheting bar 3 and a series of gears to be described shortly.

In the meantime, a few notes regarding springs are in order at this time to further develop the novelty of the device. First, unlike prior art this embodiment can wind several springs simultaneously. Secondly, unlike other prior art the leveraged and enhanced kinetic capabilities that are used to load these springs are far greater than the rotational methods of times past. It could be likened to turning a bicycle wheel by hand with the pedal versus rowing a boat. Obviously much more torque is involved in rowing a boat than is involved in turning a bicycle wheel with your hand that is on a rack and off the ground.

With this in mind, the human kinetic input into this device is much greater than that of the old rotational types because in essence, an individual is rowing with much larger muscle groups versus merely rotating with a forearm and wrist. Also, the length and weight of the ratcheted loading bar enhance human kinetic capabilities to apply torque to the winding of very large springs or dynamos. Therefore the torque limitations found in the historical Victrola motors and prior art have been addressed with a ratcheted loading bar 3 thus allowing exponential increase in torque and thus electrical output.

Since the amount of applied torque has been greatly enhanced the size of the torsion springs used in the device can now be much larger and thicker than in times past. Before springs had to be relatively small now they can be quite large. For example, old Victrola springs might have been 0.022 inches thick and 1-2 inches in width. With a properly engineered ratcheted loading bar 3 a torsion spring 0.066 thick and 8′ wide can be wound with ease even without any hydraulic intervention.

Within the world of spring strength the variance between the thickness of one spring and a larger spring is cubed to determine the increase of strength that particular spring can provide. When a spring is wider than another spring the increased strength remains a 1-1 ratio. For example if one spring is 1″ but the second spring is 2″ than the second spring would be two times as strong.

Given this understanding a spring that is 3 times as thick in the case of the above illustration would be 27 times as strong. When the same spring is 8″ wide versus 1″ wide the total increase in strength would therefore be 216 (8×27=216) times as strong as the first spring. This increased spring strength formula is readily obtained from horological institutes and master clock smiths. Using a 10 watt basis as the electrical output for new a 1″ wide 0.022 inch thick torsion spring driven device, the spring 8″ wide 0.066 thick torsion springs could potentially provide 2,160 watts or 2.2 kilowatts of output. Conservative estimates warrant a 1000-1500 watt estimated output.

Obviously the old rotational methodologies of winding Victrola springs utilizing mere forearms and wrists could not provide near enough torque to wind these springs. A ratcheted loading bar 3 that is three feet long (9 times as long as a crank handle) and weighs 5 pounds (approximately 10 times the weight of a crank handle) utilizing human back and arm muscles (at minimum of 5 times the torque capabilities of wrists and forearms) could perfume this task easily. These factors together would afford a 450 times multiple in torque when only a 217 times multiple is needed. Once again, the size and weight of the ratcheted loading bar 3 can vary and hydraulic input can be added as well. In some cases the material might be strong plastic or polymer, in other cases it might be heavy duty steel.

Lastly, with a leveraged leg press position along with the longer and heavier bar than a pedal, a leg version of the device would far exceed the capability of a bike generator (easily capable of 400 watts) once the gear trains are engineered properly and this seated arrangement can wind up even larger springs.

With this backdrop it is evident that very large springs can now be wound to rotate a sizeable dynamo capable of over 1000-1500 watts. Additionally, electricity can be stored as well without the use of batteries.

In the world of torsion springs time is measured by the length of a spring. It should therefore be apparent that the longer a spring the longer the output of electricity. Once again, the length of springs is fully scalable and dependent upon application requirements. Springs can unwind and generate electricity for minutes hours or days.

As mentioned in the introduction to this specification there is currently a ten year clock underway in Belgium. Certainly that would be more difficult with a dynamo attached but the point is that the time frame in which springs generate electricity is fully scalable. Additionally, the time of electrical generation output is also dependent upon how many springs are in sequence. The more springs in sequence the longer lasting is the output of electricity. Because the device can wind very large springs simultaneously, large amounts of electricity can be generated for relatively long periods of time. As will be discussed later, a hybrid version which can automatically be loaded with other renewable energy sources or natural gas for example and would serve primarily as storage of the electricity with generation of electricity becoming a secondary service.

Therefore the ratcheted loading bar 3 loads the spring assemblies 1-4 numbered 29, 31, 61, and 63 respectively via a first gear train beginning with primary loading gear 11 as it rotates around rotary shaft 25 and wound in one direction by utilizing a paw assembly 27 (see FIG. 4) in the same manner used in the old Victrola motors. Like FIG. 1 FIG. 2 utilizes the same right 5 and left 7 ratchet assemblies to assist in loading as well. As primary loading gear 1 9 loads loading gear 1 11 primary loading gear 2 4 simultaneously winds loading gear 3 67 as it rotates rotary shaft 2 65. Rotary shaft 2 65 and the first rotary shaft 25 do not unwind simultaneously however, they only wind up simultaneously since the shafts are separated by a frame 23 similar to the housing found in clock movements.

In one of the embodiments illustrated in FIG. 2 spring assemblies 29 and 31 are wound, tightly until a manual brake knob 17 disengages a brake pad 21 from the dynamo 1 15 thus allowing it to turn freely until such a time when one wants to stop the dynamo from turning to store the accumulated potential energy. Once the braking system as seen in FIG. 5A is disengaged as seen in FIG B and explained in the above operations of FIG. 1 a series of gears that were wound via the ratcheted loading bar 3, primary loading gear 1 9 via the loading gear 1 11 begin to turn rapidly as the first and second spring assemblies 29 and 31 unwind rapidly. However, since only the first braking system FIG. 4 is disengaged the third and fourth spring assemblies 61 and 63 still remain wound until an actuated braking system 53 becomes disengaged via a circuit board 2 45 that has a timer in it. At that time the second half of the embodiment releases and generates electricity as well.

Once again, the basic difference between embodiment FIG. 1 and embodiment FIG. 2 is that FIG. 1 does not store electricity and FIG. 2 does via spring assemblies 29, 31, 61, and 63. As spring assemblies 29 and 31 unwind they rapidly rotate a gear train beginning with a drive gear 1 33 which turns an ancillary loading gear 1 35 which rapidly turns a tertiary gear 4 36 which rapidly turns the dynamo 1 15 which generates electricity and distributes it through dynamo lead 1 37 and dynamo lead 2 39 to a circuit board 1 41.

This circuit board 1 41 then distributes a small portion of the electricity generated through a circuit board connecting wire 43 or wires that in turn flows to a circuit board 2 45 which then distributes a small portion of the electricity generated through a circuit board 2 actuator lead wire 51 which in turn releases an actuated braking system 53 that disengages a brake pad 55 in similar fashion to the manual braking systems of FIG. 5A, 5B, and 5C except that this actuated braking system 53 does not require human intervention. Once this actuated braking system 53 is disengaged spring assemblies 3 61 and spring assembly 4 63 unwind rapidly thus turning drive gear 2 8 rapidly which turns ancillary loading gear 2 59 rapidly which turns tertiary gear 5 60 rapidly which turns dynamo 2 57 rapidly which generates electricity and distributes it to circuit board 2 45 to be utilized per requirements of a particular application.

### DESCRIPTION AND OPERATION OF ALTERNATIVE EMBODIMENTS

It is important to note at this time that while FIG. 2 depicts only two dynamos this should not limit the reader into thinking that only two dynamos could be wound simultaneously nor that and actuated gear train could not subsequently wind an entirely new set of spring assemblies and dynamos. For example, another embodiment would involve four dynamos in which the first dynamo would provide immediate energy to an application while the second dynamo is used to wind up the next two spring assemblies via an actuator while the third dynamo is used for immediate energy while the fourth dynamo winds up the original two dynamos via a rotational actuator on the back side of the first two primary loading gears. Then in the same manner that the actuated braking system engages and disengages the generator, the linear actuator would engage and disengage rotary actuators that wind up the primary loading gears.

In essence, one could have one or forty dynamos in sequence released sequentially via timed actuators that provide continuous electrical generation for long periods of time. Referring back to the world of horology, a 400 day anniversary clock is commonplace and as mentioned a 10 year clock is underway. It should be apparent that sequenced embodiments can last days and months depending on the application.

Additionally, programmable logic centers would afford levels of sophistication that are customizable and scalable for complex tasks such as turning on lights at specific times, turning up heat or air conditioning, and even remote controlled stereos and TVs. It is therefore important to note that the varied embodiments of the Voorhees Enhanced Kinetic Energy Generator and Storage Device are plentiful.

Furthermore, it should be apparent that the device can just as easily be used for electrical storage only. A portion of the turbines from natural gas, coal, wind, and nuclear could be used to wind up the primary loading dears and then time release the actuated braking system. Solar panels can do the same thing via their electrochemical battery interconnects. This would then allow other less reliable renewable energy sources to store electricity in more meaningful ways with less need for chemicals and much less carbon emissions.

The device could also be used in a hybrid manner whereby the wind, solar, natural gas and other generation vehicles could be used as the primary source and the human kinetic input could be used as a secondary source. Additionally, the device can easily be used to tie back into the grid. Most states allow for grid connectivity and pay for the electricity that is generated.

The embodiments mentioned can be further used for emergency back-up systems for FEMA, it can be used to provide pumping services for gas stations when electricity is out. It can be used to supplement emergency back-up requirements for nuclear facilities and nuclear facilities communications equipment, to supplement electrical requirements for companies by tying into the circuit box and powering several circuit breakers.

It can be used in remote areas to provide residential and commercial electricity to customers to whom the electrical companies do not build out their network; particularly since many utility companies already subsidize solar panels and in some cases wind power. It can be used on military bases as supplemental renewable energy to wind and solar. It can be used in military vehicles as a remote power source that is always available. It can even be used in vehicles as a back-up method to charging a car battery. It can also be used as a battery supplement in a vehicle that adds longevity to a battery by utilizing the spring assembly some of the time versus the battery to supply rotation to the alternator.

The Voorhees Enhanced Kinetic Energy Generator and Storage Device will also significantly impact the carbon emission strategies of our country since it has virtually 0 carbon emissions.

Lastly, the Voorhees Kinetic Energy Generator and Storage Device will also significantly strengthen our national security by providing a long lasting, renewable, carbon free source of electricity that is not tied to the grid and therefore is virtually grid proof to cyber security.

### CONCLUSION, RAMIFICATIONS, AND SCOPE

Thus the reader will see that at least one embodiment of the enhanced kinetic generator will provide significantly increased kinetic input into turning a singular dynamo, a plurality of dynamos, a singular torsion spring that then turns a dynamo, or a plurality of torsion springs that turn a series of dynamos that will elevate the applications such a device well into large residential and commercial applications. Additionally, the storage capabilities of the same device have far reaching implications as well.

While the above description contains a great deal of detail and specifics, these should not be seen as limitations on the scope; rather they should be seen as an exemplification of several embodiments thereof. Many other variations are possible such as those mentioned in the alternative embodiment section of this specification.

Accordingly, the scope should be determined not by the embodiments illustrated, but by the appended claims and their legal equivalent.

What is claimed is:

1. An electrical generator and storage device comprising:
a. A rounded bar having an attached handle and an attached gear or gears that either directly rotates a dynamo or dynamos or winds up a torsion spring or springs that rotates a dynamo thus generating electrical current
b. a loading bar kinetically enhanced through length, weight, and position to allow for small and large scale kinetic input for use in rotating small and large dynamos capable of small wattage outputs to over 1000 watts of output with or without interconnecting torsion springs
c. whereby large amounts of electricity well over 1000 watts can be generated without the need for batteries, outside fuel sources, fossil fuels, wind power, solar power, nuclear power, or other forms of energy connected to the grid yet hybrid versions can include connectivity to these sources thus using the spring portions of the generator as storage.
